(19) United States
(12) Patent Application Publication
(10) Pub. No.: US 2008/0232426 A1
(43) Pub. Date: Sep. 25, 2008

(54) System of Time-Temperature Integrators

(75) Inventor: Bruce A Welt, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: University of Florida Research Foundation, Inc., Gainesville, FL (US)

(21) Appl. No.: 10/586,118

(22) PCT Filed: Jan. 18, 2005
(86) PCT No.: PCT/US05/01457

§ 371 Date: Jul. 14, 2006

Related U.S. Application Data
(60) Provisional application No. 60/537,103, filed on Jan. 16, 2004.

(51) Int. Cl. G01K 3/04; G01D 21/00

(52) U.S. Cl. 374/102; 116/207; 374/E03.004

(57) ABSTRACT

Time-temperature integrators (TTIs) are useful for providing a means to monitor safety of fresh foods, particularly foods packaged in reduced-oxygen environments. TTIs of the present invention utilize Arrhenius-type curves to offer safety margins that satisfy regulator and shelf-life requirements. One method of using TTIs of the present invention involves using duel TTIs, one as a reference and one as a safety.

### CROSS REFERENCE TO RELATED APPLICATIONS

This application claims the benefit of U.S. Provisional Application 60/537,103, filed on Jan. 16, 2004, which is hereby incorporated by reference in its entirety, including all tables, references and figures.

This invention was made with government support under National Science Foundation grant number 9316887. The government has certain rights in the invention.

### BACKGROUND OF THE INVENTION

Reduced-oxygen packaging (ROP) of fresh foods offers at least 2 major benefits: (1) improved production, handling and distribution efficiency and (2) shelf-life extension. Reduced-oxygen packaging is usually performed with vacuum packaging (VP) or modified atmosphere packaging (MAP). Vacuum packaging involves removal of gas from a package, whereas MAP involves altering the gaseous composition of the atmosphere within a package in a prescribed manner.

Introduction of VP for distribution of chilled beef is recognized as one of the most important developments in meat handling during the 20th century Robertson 1993). Prior to this innovation, large portions of animal carcasses were transported to local butchering operations. Today, slaughter and gross portioning are performed in well controlled, centralized facilities. Unused carcass parts are removed prior to distribution. Beef products are now internationally available as standardized, easily handled, vacuum-packaged units known as “boxed beef”.

Once beef is vacuum packaged, the residual gaseous environment becomes deficient in oxygen and enriched in CO₂. This type of environment has been shown to be beneficial for two reasons: (1) growth of aerobic microorganisms responsible for spoilage is reduced and (2) CO₂ dissolves in moist foods and establishes equilibrium with carbonic acid, which reduces pH (increase acidity) and further inhibits microbial growth. Ample research has shown that many other types of fresh foods can also benefit from ROP including poultry and seafood, as well as respiring products such as fruits and vegetables.

Botulism is a serious paralytic disease caused by eating foods that contain a potent nerve toxin produced by the bacterium Clostridium botulinum. Historically, botulism was associated with canned foods that were either damaged or insufficiently sterilized. Recent trends toward ROP of fresh foods are creating more avenues of risk for this disease. Reduced-oxygen packaging of fresh or minimally processed seafood may be one of the most significant risks facing industry and consumers since it has been shown that toxin may be present prior to obvious spoilage (FDA 2001). This danger is compounded by the fact that seafood is often cooked less severely than other foods. Therefore, solving safety issues related ROP of fresh seafood may pave the way for application of ROP technologies to many types of foods.

Seafood consumption in the United States has been steadily increasing since the mid-1950s (Gerdes and Valdez 1991). Data from the Florida Department of Environmental Protection-Marine Fisheries values annual landed seafood in Florida at over $200 million. Demand for fresh seafood continues to grow, while our ability to preserve product quality remains limited. Although studies have shown that MAP may be capable of extending the shelf-life of fresh fish (Hong and others 1996), its use is limited due to the danger of pathogenic bacteria causing toxicity prior to obvious spoilage. This is due to two diametrically opposed roles of spoilage bacteria. On one hand, it is desired to reduce spoilage organisms to preserve quality. On the other, the Food and Drug Administration (FDA) is concerned that if spoilage organisms are reduced or eliminated, products may become toxic prior to onset of noticeable spoilage.

Spoilage begins as soon as fish die. Normal defense mechanisms seize, and a series of changes caused by bacteria, enzymes and chemical action allow spoilage to begin. Bacteria are believed to be the most important cause of seafood spoilage (Price 1990). In addition to bacteria, oxygen in the atmosphere can attack fats causing rancidity, off odors and off-flavors. This is especially important in fatty fish such as salmon and mackerel. Evidence of oxidative damage has been noted while attempting to preserve fish on deep-water fishing vessels, where it was found that gills of ice-immersed fish exposed to “air pockets” turned brown, while unexposed gills remained red (Scarlatti 1965). Under traditional conditions, aerobic bacteria tend to be the major cause of spoilage in fish. Therefore, researchers have been attempting to extend the shelf life of fresh fish by reducing exposure to oxygen via modified atmosphere packaging. Although it has been shown that spoilage can be delayed by removing oxygen (Stammen and others 1990; Penney and others 1994; Hong and others 1996); doing so introduces the danger that apparently unspoiled fish may contain C. botulinum toxin. For this reason, the FDA has instituted strict guidelines for the use of ROP for seafood. It is likely that this issue is also central to FDA's reluctance to approve irradiation as a means to extend the shelf life of fresh seafood (Federal Register 1990).

C. botulinum forms toxin more rapidly at higher temperatures than at lower temperatures (Table 1). The minimum temperature for growth of C. botulinum type E and nonproteolytic type B and F is believed to be around 3.3° C. (38° F.). As shelf life of refrigerated foods increases, more time is available for C. botulinum growth and toxin formation. As storage temperatures increase, time required for toxin formation decreases. The Food and Drug Administration encourages industry to expect that proper refrigeration temperatures will not be maintained during storage, distribution, display or consumer handling of refrigerated foods. Surveys of retail display cases indicate that temperatures of 7 to 10° C. (45 to 50° F.) are not uncommon (FDA 2001). Surveys of home refrigerators indicate that temperatures can exceed 10° C. (50° F.) (FDA 2001).

To assist in identifying potential hazards in food processing and distribution process, FDA offers three factors that are conducive to toxin formation, two of which are related to the packaging (FDA 1998).

(1) Vacuum packaging or modified atmosphere packaging. Because most of these packaging methods exclude or reduce the amount of oxygen in the package, conditions may be favorable for C. botulinum growth and toxin formation; (2) packaging in hermetically sealed containers (such as double seamed cans, glass jars with sealed lids, heat sealed plastic containers) or packing in oil. These and similar processing/packaging techniques prevent the entry of oxygen into the container. Any oxygen present at the time of packaging may be rapidly depleted by the activity of spoilage bacteria, resulting in a reduced-oxygen environment that is favorable for C. botulinum growth and toxin formation.

Evidence of the danger of toxigenesis prior to observable spoilage at mildly abusive temperatures has been demonstrated (Post and others 1985). Table 1 summarizes data reported by Reddy and others (1996, 1997a, 1997b). These studies demonstrate the potential of MAP to extend acceptable shelf life, and the remote possibility of toxigenesis prior or coincident to obvious spoilage at mildly abusive temperatures.

TABLE 1
Data demonstrating potential for toxigenesis prior or coincident to observable spoilage
under mildly abusive temperature conditions.

| | | | Temperature (° C.) | | | | | |
|---|---|---|---|---|---|---|---|---|
| | | | 4 | | 8 | | 16 | |
| | | | Spoilage | Toxic | Spoilage | Toxic | Spoilage | Toxic |
| | | | (d) | (d) | (d) | (d) | (d) | (d) |
| Reddy and | Tilapia | Air | 10 | >47 | 6 | 20 | 3 | 4 |
| others 1996 | | 75% CO₂/25% N₂ | 80 | >90 | 17 | 40 | 4 | 4 |
| | | Vacuum | 47 | >90 | 10 | 17 | 3 | 3 |
| Reddy and | Salmon | Air | 24 to 27 | >66 | 13 to 17 | 17 | 4 | 4 |
| others | | 75% CO₂/25% N₂ | 55 to 62 | >80 | 20 to 24 | 24 | 5 to 6 | 4 |
| 1997a | | Vacuum | 34 to 38 | >66 | 6 to 10 | 10 | 3 | 3 |
| Reddy and | Catfish | Air | 13 | >54 | 6 | 9 | 3 | 3 |
| others | | 75% CO₂/25% N₂ | 38 to 40 | >75 | 13 | 18 | 4 | 4 |
| 1997b | | Vacuum | 20 to 24 | 46 | 6 | 6 | 3 | 3 |

Recently, Skinner and Larkin (1998) proposed an empirical relationship that provides a conservative prediction for the time required to observe C. botulinum toxin as a function of temperature. The Skinner and Larkin relationship is a simplified and more conservative version of an expression proposed by Baker and Gerigeoris (1990). The Skinner and Larkin relationship follows:

Log(L)=0.65−0.0525T+2.74/T (1)

where L is the “lag time” or “time-to-toxigenesis” in d, and T is the temperature in degrees Celsius. FIG. 1 shows a plot of the Skinner and Larkin curve. The Skinner and Larkin curve represents an empirical border around virtually all known conditions where growth of C. botulinum have been shown to occur. Therefore, the 2 regions shown in FIG. 1 represent the best understanding of conditions where C. botulinum can and cannot grow.

It is well known that properties of natural and synthetic materials change over time. In the case of foods, particularly refrigerated fresh foods, such changes are generally-undesirable, and reflect deterioration of food quality and/or safety. It is also generally recognized that the rate at which such changes occur vary with temperature. For the case of toxin liberation by C. botulinum, Eq. 1 describes this temperature sensitivity.

Germination of bacterial spores and the growth of the bacteria are highly complex processes that depend on many factors (Sarathehandren and others 1977). Due to the conservative nature of the Skinner and Larkin relationship, such complex issues may be ignored in order to focus on one critical parameter, namely temperature.

Temperature is often cited as the most important factor affecting food safety and quality (Shimoni and others 2001). Since changes in foods often involve highly complex and poorly understood mechanisms, time-temperature integrators (TTIs) are designed using fairly simple physical and/or chemical systems that have well understood temperature sensitivity characteristics. Therefore, the purpose of a TTI system is to relate a readily observable change in the TTI to changes that are not as readily determined in foods. Specifically, TTIs designed to ensure safety of fresh ROP seafood should allow an observer to relate TTI readings to the Skinner and Larkin (1998) relationship (Eq. 1).

Commercial TTI vendors often provide “endpoint” data to describe TTI performance. For example, Cox Technologies (Belmont, N.C., U.S.A.) recommends its VITSAB M2-10 for seafood. The designation “M2-10” suggests that the TTI should expire in 10 days at 2° C. Additional time-temperature performance combinations for the M2-10, as provided by the company, compared with Eq. 1 are shown in Table 2.

TABLE 2
Comparison of VITSAB M2-10 expiration to Skinner and Larkin relationship (Eq. 1).
All values in days.

| | Temperature (° C.) | | | | | | | | | | |
|---|---|---|---|---|---|---|---|---|---|---|---|
| | 0 | 1 | 2 | 3 | 4 | 5 | 6 | 7 | 8 | 9 | 10 |
| M2-10 | 14.0 | 12.0 | 10.0 | 8.4 | 7.0 | 6.0 | 5.0 | 4.0 | 3.5 | 2.5 | 2.0 |
| Skinner and Larkin | | 2175.2 | 82.2 | 25.5 | 13.3 | 8.6 | 6.2 | 4.7 | 3.7 | 3.0 | 2.5 |
| (Eq. 1) | | | | | | | | | | | |

Other approaches to TTI approximations and techniques to manufacture TTI devices can be found in U.S. Pat. Nos. 5,667,303; 6,244,208; 6,435,128; and 6,614,728. These devices all monitor the cumulative temperature exposure of a product or package to temperature.

Interestingly, information about the path between endpoints is not typically provided. In other words, the current approach to TTI design focuses solely on matching temperature sensitivity of the TTI to the underlying process. Although this approach may be theoretically sound, it may lead to technically correct, yet poorly behaved TTIs that are difficult to interpret subjectively.

The rate at which the TTI readings change with time can often be modeled with well known kinetic expressions. For instance, the rate of change of an observable TTI parameter, A, can be said to follow the general form:

$$\pm \frac{d A}{d t} = {kA}^{n} \qquad ( 2 )$$

where k is often referred to as the reaction rate constant, and n is the reaction order. In highly complex systems such as foods, global changes often follow pseudo-zero (n=0) or pseudo-first order (n=1) kinetics.

First-order kinetic behavior is often observed in nature. Well-known examples are radioactive decay, and exponential-phase bacterial growth. In such cases it is easy to see that the rate of change of A at any given time is proportional to the magnitude of A at that time:

$$\pm \frac{d A}{d t} = kA \qquad ( 3 )$$

Conversely, zero-order behavior is not observed in nature as often. However pseudo-zero order behavior is observed in systems where a potentially limiting component is available in sufficiently excessive amounts that the limitation becomes insignificant. Such behavior is observed in catalyzed reactions in which catalyst concentration is abundant. For the zero-order case, the rate of change is constant:

$$\pm \frac{d A}{d t} = k \qquad ( 4 )$$

Solving Eq. 3 and 4 provides relationships that can be used to describe the behavior of zero and first order TTIs between the specified times.

$$\begin{matrix}\underline{n = 0} & \underline{n = 1} \\ \pm \frac{d A}{d t} = k & \frac{d A}{d t} = \pm kA ( 5 {a}_{0} , 5 {a}_{1} ) \\ \pm {\int }_{{A}_{0}}^{A} d A = k {\int }_{0}^{r} d t & {\int }_{{A}_{0}}^{A} d A = k {\int }_{0}^{r} \pm d t ( 5 {b}_{0} , 5 {b}_{1} ) \\ A = {A}_{0} \pm kt & A = {A}_{0} {e}^{\pm kt} ( 5 {c}_{0} , 5 {c}_{1} )\end{matrix}$$

Equations 5c₀ and 5c₁ represent the response paths that zero and first order TTIs would provide. If it is assumed that the response of the VITSAB M2-10 follows zero order kinetics, then the reaction rate at 2° C. would be:

$$k = \frac{{A}_{0}}{t} = \frac{100 \% - 0 \%}{10 days} = 10 days = 10 \% per d \qquad ( 6 )$$

where 100% and 0% refer to the amount of observable response remaining at the beginning and end of the 10 days, respectively. In other words, when the M2-10 is stored at 2° C., an observer could expect to see a similar amount of response during each of the 10 days until expiration. In this case that amount would be 10% of the total response per day.

If the M2-10 follows first-order kinetics, then we would need to know more about the state of the TTI when it expires in order to be able to determine the reaction rate constant, k, and to predict the path of the response. This is due to the fact that first-order behavior asymptotically approaches the expiration point and never actually achieves complete expiration. For this reason, the end of the TTI's response must be defined as a fraction of the TTI's total response, A/A0. With this additional information, the reaction rate constant may be calculated as follows:

$$k = \frac{ln ( A / {A}_{0} )}{t} \qquad ( 7 )$$

FIG. 2 shows expected response paths for the VITSAB M2-10 stored at 2° C., assuming both zero and 1st-order kinetics. For the first order case, several possible endpoint specifications are shown.

Note that all of the curves in FIG. 2 satisfy the M2-10 specification, in that they all reach the specified endpoint in 10 days (240 h) at 2° C. Although each of these paths would provide a conservative response relative to the Skinner and Larkin formula for C. botulinum, the differences in the paths raise some practical concerns with regard to actual use. To illustrate, consider the first order TTI for which the end of response is A/A₀=0.01. Under constant temperature storage at 2° C., an observer would note a fairly rapid response during the first two to three days, but would then see very small changes until expiration. Conversely, for the first order response when the endpoint A/A₀=0.7, the rate of change would appear to be fairly slow, but consistent. For the zero-order case, the response would appear constant throughout, as expected.

Upon comparing the zero-order and first-order A/A₀=0.7 response curves, it is clear that, while both offer consistent changes over time, the overall response of a corresponding first-order TTI would be much more subtle than the zero-order TTI. Therefore, given a choice, the zero-order behavior should be preferable.

As shown, an appropriate assumption of reaction order, n, allows determination of the associated reaction rate constant, k, from endpoint specifications. The Arrhenius relationship (Eq. 8) often describes how k varies with temperature:

$$k = {k}_{0} e ( \frac{- Ea}{RT} ) \qquad ( 8 )$$

where Eₐ is the activation energy; R is the ideal gas law constant; T is absolute temperature; k₀ is a constant. Generally, reaction rate constants increase with temperature. The sensitivity of the rate constant to temperature is governed by the magnitude of Eₐ. For two different reactions or, in this case TTIs, with different Eₐ values, Eq. 8 dictates that the reaction rate constant with the greater activation energy will change by a greater amount for a given change in temperature.

Arrhenius parameters, k₀ and Eₐ, are typically determined from a plot of ln(k) versus inverse absolute temperature. Equation 9 shows that when such a plot produces a line, the slope is equal to −Ea/R and the intercept is ln(k₀).

$$ln ( k ) = ln ( {k}_{0} ) - \frac{{E}_{a}}{R} ( \frac{1}{{T}_{absolute}} ) \qquad ( 9 )$$

Since it is likely that most commercial TTIs demonstrate Arrhenius temperature sensitivity, it may be useful to transform the empirical Skinner and Larkin (1998) formula (Eq. 1) into a corresponding Arrhenius relationship, so that appropriate comparisons can be made. As previously noted, the reaction order, n, must be assumed in order to convert Skinner and Larkin (1998) lag-times into reaction rate constants.

Physically, the end of the Skinner and Larkin lag-time, L, corresponds to germination of C. botulinum spores, growth of bacteria and liberation of toxin. During the lagtime, there are no convenient measurements that can be made to estimate the amount of lag-time already consumed or remaining. The critical and practical aspect is that there must be an absolute understanding that once the safe lag-time is depleted, the ROP food is unconditionally surrendered. In other words, the endpoint is clear, definite, and absolute; an inherent characteristic of zero order kinetics. Moreover, the endpoint is not an arbitrary point on an asymptotic curve, an inherent characteristic of first order kinetics. Therefore, it should be sufficient and conservative to assume that consumption of lag-time follows the most direct path, which is defined by zero-order kinetics. However, this does not mean that the approach described here is restricted to TTIs with zero-order kinetic responses. The approach can be applied equally well to TTIs with first-order, or other types of kinetic responses. However, given the physical nature of the consumption of lag-time, it is suggested that TTIs offering zero-order kinetics are preferable. Therefore, development of the approach below focuses on the case of zero-order kinetics. Using the zero-order kinetic assumption, Skinner and Larkin (1998) reaction rate constants may be calculated directly from lagtimes calculated in a manner similar to that described by Eq. 6:

$$k ( T ) = \frac{100}{L ( T )} \qquad ( 10 )$$

FIG. 3 shows the Skinner and Larkin (1998) formula in Arrhenius form, assuming zero order kinetics. This curve shall be referred to as S&L-Arrhenius curve.

Prior to applying FIG. 3 in the development of methodology appropriate for TTIs, it is important to be able to interpret FIG. 3 properly. Since FIG. 3 was created with the assumption of zero-order kinetics, Eq. 5a₀ dictates that the reaction rate constant, k, is also equivalent to the rate of loss of lagtime. Therefore, when comparing rates of change of zero-order indicator systems to that of the modified S&L-Arrhenius curve in FIG. 3, points above the curve represent TTI changes that are faster than consumption of lag-time, while those below represent TTI changes that are slower than consumption of lag time. Since the objective of any TTI is to provide an accurate, yet conservative indication of the consumption of lagtime (or other corresponding process), it is appropriate for zero-order TTI response curves to approach the S&L-Arrhenius curve from above. In other words, it is desirable to be as close to the S&L-Arrhenius curve as possible, but never below the curve.

Time-temperature integrator technology offers a promising approach to monitoring product quality and safety. However, a greater understanding of TTI performance attributes is required before confidence in their ability to ensure product safety is achieved. Specifically, procedures need to be established that define how TTIs are to be read, as well as how such readings are to be used. Once such procedures are established, studies need to establish appropriate statistics related to expected performance. These statistics will allow development of limits that will define an appropriate proximity for mean TTI performance to the established border of safety.

Additionally, it is important to understand how external influences might affect TTI performance. Such influences might include (1) handling, storage and shelf-life of the TTIs, (2) location of a TTI on a package, (3) weight of other packages on a TTI, (4) effects of different forms of light in TTIs, and (5) brief exposures of TTIs to environment extremes before and during use.

The time required for C. botulinum spores to germinate, grow and liberate toxin is often reported as a “lag time” or “time to toxigenesis” (Skinner and Larkin 1998). It can be useful to consider this period of time as a consumable resource with specific initial and ending conditions, namely 100% of lag time remaining and 0% of lag time remaining, respectively. The actual path taken between these 2 points is not well understood, but it is not particularly important since the underlying food is safe at all conditions between these 2 points. At the very least, it is conservative to assume that the path taken is a straight line under constant thermal conditions. This consideration provides a useful, but not restrictive performance target for time temperature integrator devices. The concept of lag-time is not limited to C. botulinum spores growing in fish but can be used to approximate the lag time of any pathogenic microorganism, for example, but not limited to, C. Botulinum, enterotoxigenic E. coli, salmonellae sp, exotoxin shigalla dysenteriae, staphylococcus aureus, enterotoxin Klebsiella pneumoniae, Bacillus cereus, Vibrio parahaemolyticus, Vibrio cholerae, Campylobacter jejuni, Campylobacter jejuni, Yersinia enterocolitica, Exotoxin Pseudomonas aeruginosa, C. perfringens, Versinia enterocolitica, and Listeria monocytogenes.

The skilled artisan would also understand that lag time can also be applied to sprouting in root vegetables and ripening of live foods like fruits. Lag time can also be used to indicate spoiling. The additional consideration of the inherent shelf-life of a particular fresh food packaged in a reduced-oxygen environment, provides a safe and practical product-specific TTI performance specification.

### BRIEF SUMMARY OF THE INVENTION

The present invention comprises a system of time-temperature integrators (TTI) to ensure food product safety, particularly reduced oxygen packaged fresh fish A first TTI predicts when the product lagime is depleted. A second TTI is useful as a reference indicator to analyze inefficiencies in supply chain temperature. The reaction mechanisms that drive the indicator are both zero order reactions. The first TTI is designed to performed according to curve E of FIG. 6, which is a predictive model for the depletion of lagtime. The second TTI is designed to perform more sluggishly to changes in temperature for temperatures below some predetermined critical temperature and more sensitively for temperatures above the critical temperature.

The method of using the TTIs comprises observing the rates of change in the indicator mechanism and analyzing the changes using a color chart or a hand held spectrometer. If the change is greater in the first TTI, the food has been consistently exposed to desirable temperatures. If the change is greater in the second TTI, the food product has been exposed to undesirable temperatures although the product may be safe to eat.

### BRIEF DESCRIPTION OF THE FIGURES

FIG. 1—The Skinner and Larkin (1998) relationship (Eq. 1).

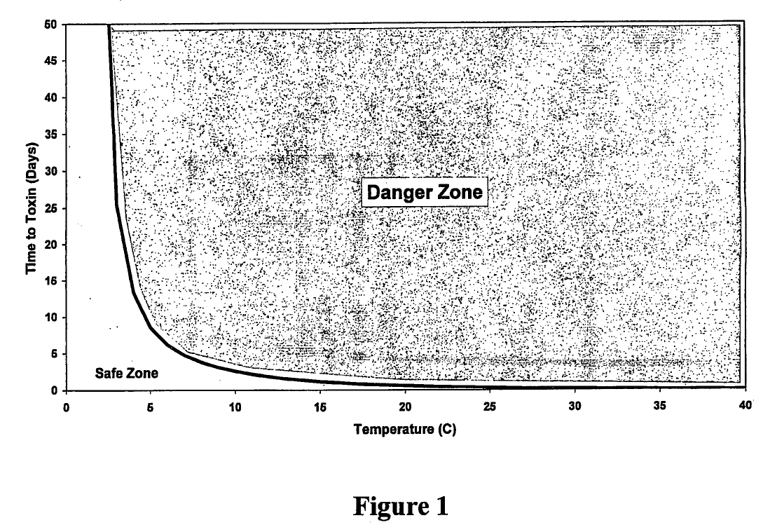

FIG. 2—Possible response paths of the Vitsab® M2-10 TTI under constant temperature storage at 2° C., assuming zero and first order kinetics.

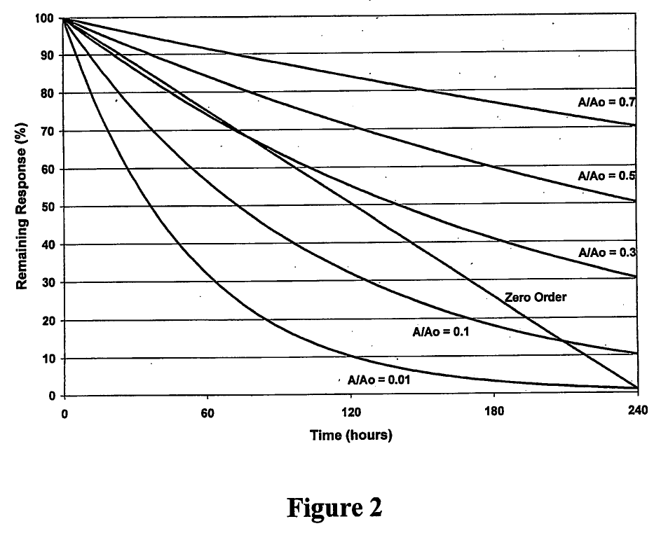

FIG. 3—Arrhenius plot of Skinner and Larkin (1998) formula assuming Zero order kinetics.

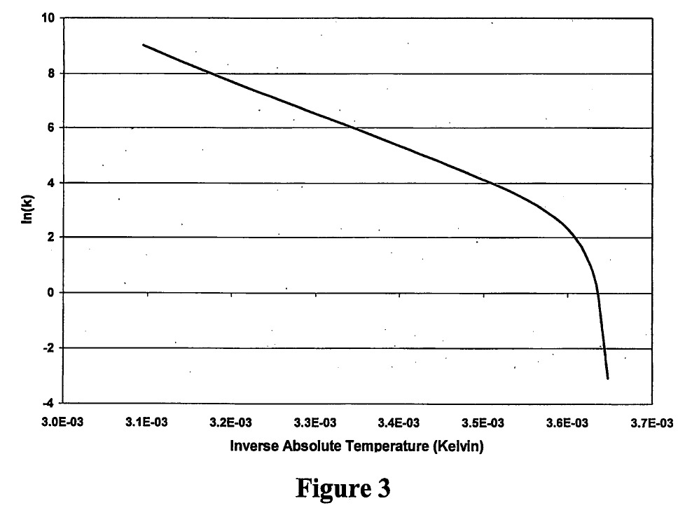

FIG. 4—Depiction of extremes for specifying zero-order TTI performance.

FIG. 5—Arbitrary approaches for compromising between extremes shown in FIG. 4.

FIG. 6—Proposed method for specifying zero-order TTI performance.

FIG. 7—Desired tangent line that contains P1 must either be selected from more than one possible solution, or the search for P2 must be constrained to the region of particular physical interest.

FIG. 8—Simulation of TTI performance (P1 specified by 18-d shelf-life at 1° C.) versus Skinner & Larkin (1998) lag-time under abusive distribution conditions.

FIG. 9—Simulation of TTI performance (P1 specified by 18-d shelf-life at 1° C.) versus Skinner & Larkin (1998) lag-time under abusive daily temperature cycles.

FIG. 10—Duel indicator system at important temperatures.

FIG. 11—Response patterns for a safety TTI and a reference TTI relative to actual temperature.

### DETAILED DISCLOSURE OF THE INVENTION

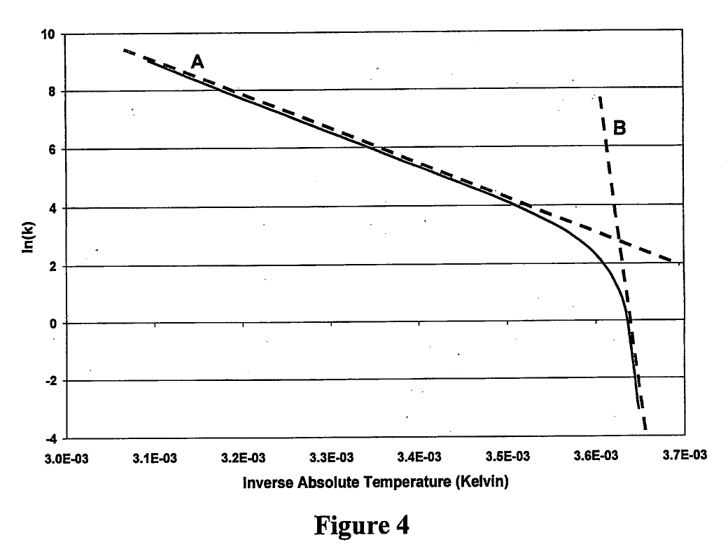

The manner in which the S&L-Arrhenius curve is used to design and/or specify TTI performance depends on the nature of the TTI response. Ideally, one would prefer TTIs to behave identically to the S&L-Arrhenius curve. However, this may be difficult to achieve for any given indicator system. A viable alternative could include TTIs with zero-order response characteristics, and an Arrhenius curve that is as close to the S&L-Arrhenius curve as possible, but without crossing below the S&L-Arrhenius curve. FIG. 4 presents two such Arrhenius curves (lines A and B) that represent the extremes of all possible curves that satisfy this requirement.

Although zero-order TTIs offering the performance depicted by lines A and B (FIG. 4) would provide conservative responses relative to the Skinner and Larkin (1998) formula, it is worth noting the practical implications of these extreme cases. Before doing so, it is worth noting three points regarding Arrhenius plots. First, increasing values of ln(k) represent increasing values of the reaction rate constant, k. Second, for the case of zero-order kinetics, the rate constant is equal to the reaction rate. Third, the abscissa of an Arrhenius plot is “inverse absolute temperature,” therefore, temperature decreases toward the right and increases to the left.

Consider a TTI with temperature sensitivity described by curve B (TTI-B) in FIG. 4. This TTI closely matches the S&L-Arrhenius curve at low temperatures, but becomes increasingly faster (more conservative) as temperature increases. For the case of ROP seafood, TTI-B would perform well for product distributed and stored under properly controlled temperatures. However, the TTIs would quickly expire under brief exposure to even moderate temperatures. In most cases of slight to moderate temperature abuse, TTI-B would expire well before the underlying products would actually become unsafe to consume. The result being that even insignificant lapses in temperature control during distribution or storage would likely result in significant waste of otherwise safe product.

Now consider TTI-A in FIG. 4. Time-temperature integrator-A becomes increasingly conservative (faster) than consumption of lag time at low temperatures. For the case of ROP seafood, TTI-A will expire well before toxigenesis even when product temperature is perfectly controlled throughout distribution and storage. Time-temperature integrators-A would become increasingly accurate as thermally abusive conditions become more severe.

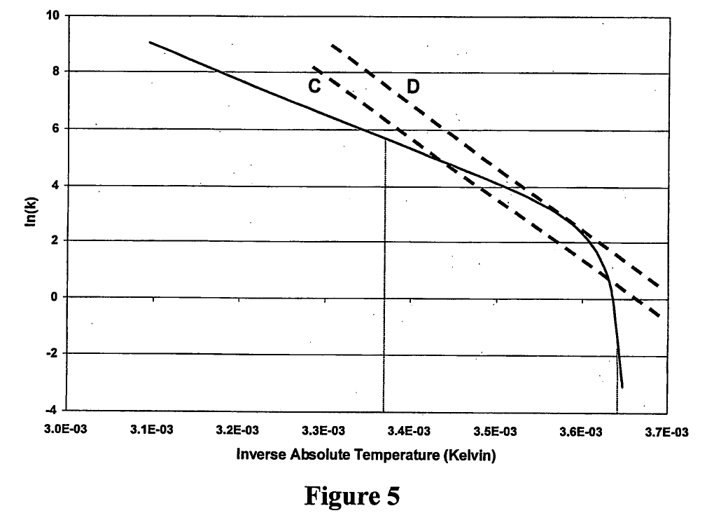

FIG. 5 depicts one seemingly straightforward, yet arbitrary and potentially dangerous attempt to compromise between the extremes (curve C), as well as a safer alternative (curve D).

Curve C (FIG. 5), can be created via linear regression of either the entire S&L-Arrhenius curve or some arbitrarily selected sub-region. Since it is the purpose of any regression to find the path of least error through a set of data, it should be expected that the resulting line will pass above and below the elected data points (curve C, FIG. 5). Clearly, a zero-order TTI with curve C performance would not be conservative within the temperature range where the curve falls below the S&L-Arrhenius curve.

The dangerous region of curve C can be avoided by applying an additive offset of an amount equal to the greatest difference between curve C and the S&L-Arrhenius curve, resulting in curve D (FIG. 5). Curve D represents a safe and conservative performance specification for a zero-order TTI, however, it retains the arbitrary nature of curve C, because it depends on the particular range of data used in the regression.

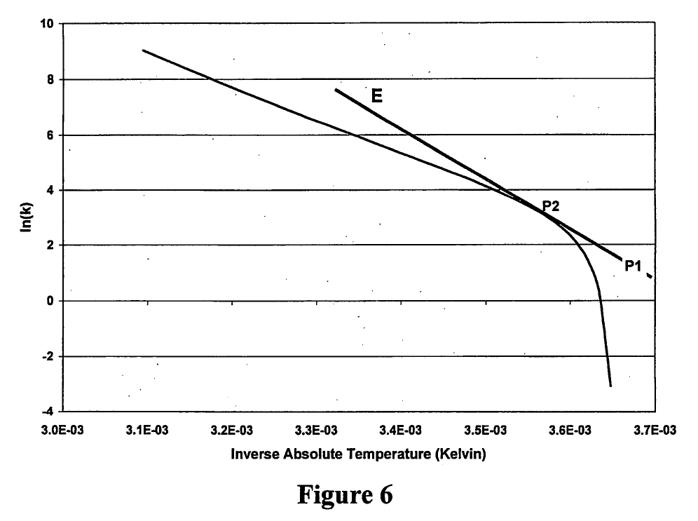

FIG. 6 represents a more specific approach that is conservative, practical and not arbitrary. Curve E (FIG. 6) is constructed from two points, one that is relevant to the product, and another from the S&L-Arrhenius curve. The result is a curve that provides (1) an appropriate response when temperature control is excellent, (2) the smallest possible excessive response as temperature increases, while (3) ensuring a safe and conservative response under all temperatures. The product-related point, P1, is defined by the actual shelf life realized under ideal conditions. In other words, P1 represents the maximum achievable shelf-life of the product. For example, if 20 days of shelf-life are achieved at 0° C., then P1 is defined on the plot as {1/273.15, ln([100%/−0%]/20 days)}. The second point, P2, is defined by the tangent to the S&L-Arrhenius curve that contains P1. Curve E (FIG. 6) offers a practical compromise between realistic shelf life and; unnecessary waste of otherwise safe product. A zero-order TTI with curve E performance (TTI-E) provides the appropriate shelf-life at low temperature, accurate safety indications at moderate temperatures, and conservative indications under increasingly abusive conditions.

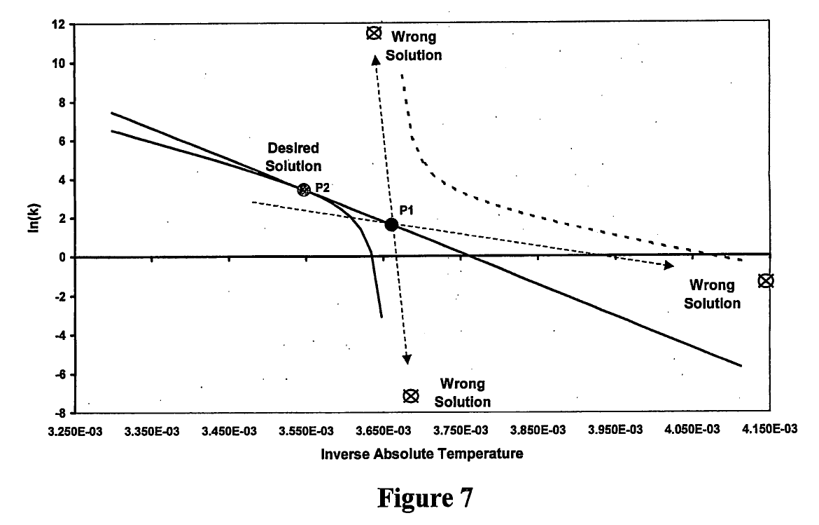

Point P2 can be found using many widely available tools such as the Solver feature of Microsoft Excel. However, it is important to note that it is possible to find more than one mathematical solution. Therefore, it is necessary to either discard undesirable solutions, or to constrain the search to a region appropriate to the physical nature of the problem. FIG. 7 shows the behavior of the Skinner & Larkin Arrhenius curve over a wider range of temperature values. For the case of unfrozen ROP seafood, identifying the proper solution or constraining the search for the desired solution is not too difficult, because P1 will likely be defined by temperatures approaching 0° C. (1/273.15) from the positive side (fresh fish, by definition, is unfrozen). Therefore, the desired solution is likely at a temperature somewhat above that of P1. For a number of practical situations, constraining the search for P2 to temperatures above 1° C. has proven to be sufficient. The slope of the tangent to the S&L-Arrhenius curve is defined by the derivative of this curve. The equation for the slope of the tangent line is

$${f}^{′} ( x ) = - ln ( 10 ) [ \frac{0.0525}{{x}^{2}} + \frac{2.74}{{{x}^{2} ( \frac{1}{{x}^{2}} - 273.15 )}^{2}} ] \qquad ( 11 )$$

where x is inverse absolute temperature (1/T_{abs}).

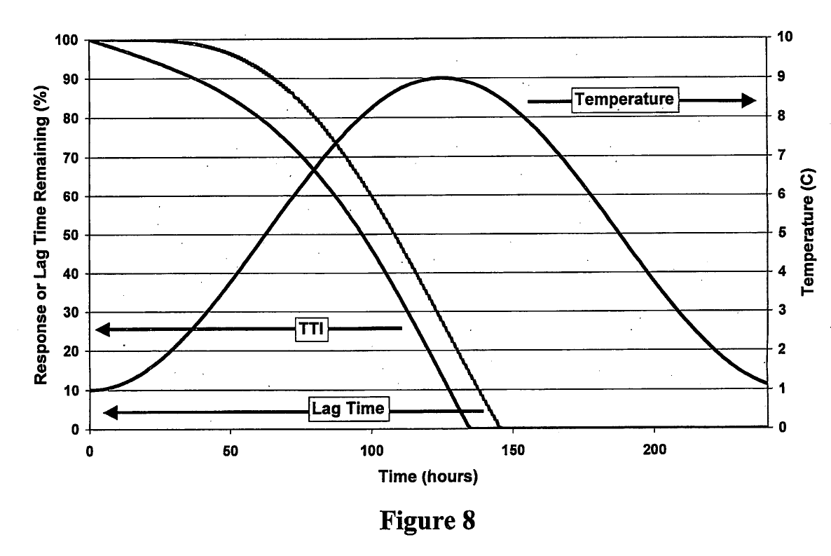

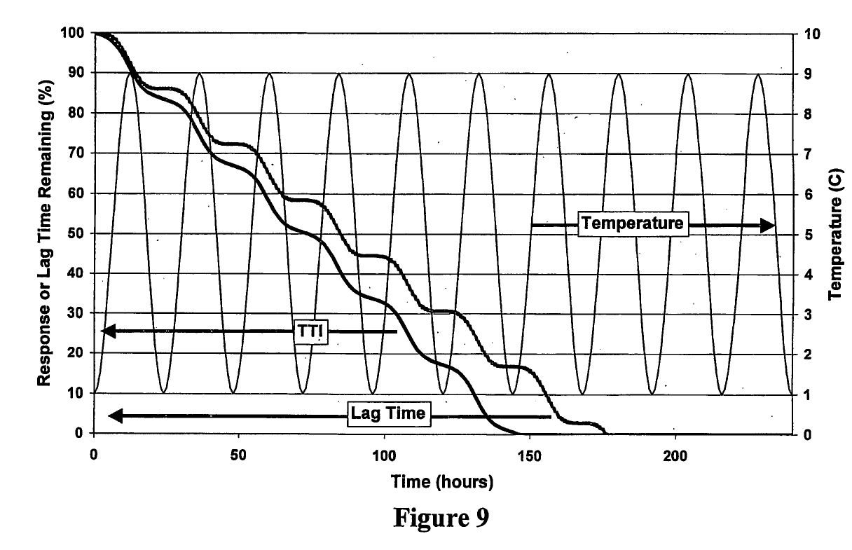

FIGS. 8 and 9 show predicted response curves for a zero-order TTI constructed in a manner described by curve E (FIG. 6). For this case, point P1 was defined by a product that provides 18 d of shelf life at 1° C. The tangent to the S&L-Arrhenius curve that contains P1 was found to occur at 8.0° C. The line passing through these points provides the desired Arrhenius specification for the desired zero-order TTI:

$$ln ( k ) = 64.86 - \frac{17311}{{T}_{absolute}} \qquad ( 12 )$$

Equations 12 and 1 were used to simulate response characteristics under abusive dynamic thermal conditions. In each case, the dynamic thermal condition was generated using the following sine-squared function:

$$T ( t ) = {T}_{Base} + A {sin}^{2} ( \frac{2 π t}{P} ) \qquad ( 13 )$$

where T is temperature in ° C., T_{base} is a base or minimum temperature of the cycle, A is the amplitude of the cycle (maximum temperature reached in a cycle is T_{base}+A), P is the period of the cycle, and t is time in h. Response values were calculated using a 1-hour time interval. Temperature values equal to 10% above the mean temperature for each interval was used for kinetic response calculations (Welt and others 1997).

FIG. 8 depicts a situation in which product is manufactured and packaged under controlled conditions of 1° C., then transits a poorly controlled distribution chain, but then returns to controlled conditions for storage and/or sale (T_{base}=1° C., A=8° C., P=500 h).

FIG. 9 depicts a daily fluctuation of temperature between 1 and 9° C. (T_{base}=1 C, A=8° C., P=48 h).

As expected, FIGS. 8 and 9 demonstrate that a zero-order TTI engineered to perform in accordance with Eq. 12 would provide a safe and conservative indication. Under any possible conditions, the TTI is expected to expire prior to the conservative prediction of toxigenesis provided by the Skinner and Larkin (1998) formula (Eq. 1).

One embodiment of the present invention comprises a system of TTIs useful for monitoring food safety. Advantageously, a system of TTIs allows the user to monitor the temperature changes during the supply chain history in addition to providing information to the depletion of lag time. Preferably, the system comprises two TTIs. Preferably, the TTIs indicate food safety information using changes of color. The changes of color can be analyzed by use of a handheld spectrometer or by observation and comparison with a color chart. In yet another embodiment, the TTIs are digital and perform calculations for the approximation of lag time. The results are then displayed and/or transmitted to the appropriate personal.

The first TTI, or safety TTI, is designed, utilizing techniques known in the arts, with a larger activation energy for the reaction driving the indicator mechanism. The reaction can be, for example, an enzyme-lipid reaction or a viscoelastic material designed to decay according to Equation 12. In addition to showing the rate of decay of the lagtime, the first TTI is designed to indicate complete depletion of lagtime. At this indication, the food product is no longer safe to eat.

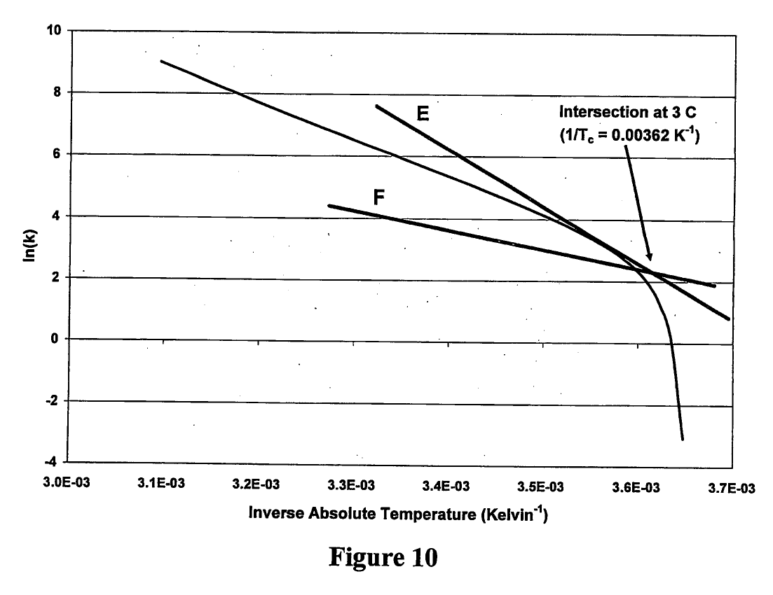

In order to supply more information about the food supply chain, the first TTI can be used in conjunction with a second TTI. The second TTI, or the reference TTI, is preferably manufactured to perform a zero order decay with a different activation energy, or temperature sensitivities, than the reaction mechanism of the first TTI; however, the invention also applies to non-zero reaction orders as well. The reaction driving the second TTI preferably has a smaller activation energy relative to the first TTI, and the second TTI is not as sensitive to temperature as the first TTI. Optionally, the second TTI can be designed with a larger activation energy, resulting in opposite behavior than is described; however, a second TTI with smaller activation energy is preferred and used for description. The reaction curve of the second preferred TTI crosses the reaction curve of the first TTI at a critical temperature selected for the food product by the operators (see, for example FIG. 10). Storage at temperatures greater than the critical temperature results in larger decay in the second TTI relative to the first TTI.

Another aspect of the present invention is a method of using a dual TTI system to monitor food safety. The method comprises comparing changes in the indicator systems of a first TTI to a second TTI, where the TTIs are constructed using the reaction design data of the present invention, and the second TTI, preferably, has a smaller activation energy, or a different temperature sensitivity, than the first TTI. For the same change in temperature, the first (safety) TTI changes color more quickly when the temperatures are lower than the critical temperature. For temperatures greater than the critical temperature, the color changes more quickly in the second (reference) TTI. Optionally, the second TTI has a larger activation energy than the first TI, which results in the opposite behavior. In other specific embodiments, the rates of change are displayed digitally, by variable indications against a fixed scale or any combination of the foregoing.

A method of the present invention utilized these temperature dependent qualities of the TTIs to develop a food safety inquiry. A method, wherein the rate of change is indicated by changes in color, comprises observing the change of color of the first TTI, observing the change of color of the second TTI, and comparing the changes. For ease in interpretation, a color chart showing possible changes in color or a hand-held spectrometer can be used to determine precisely the change in color

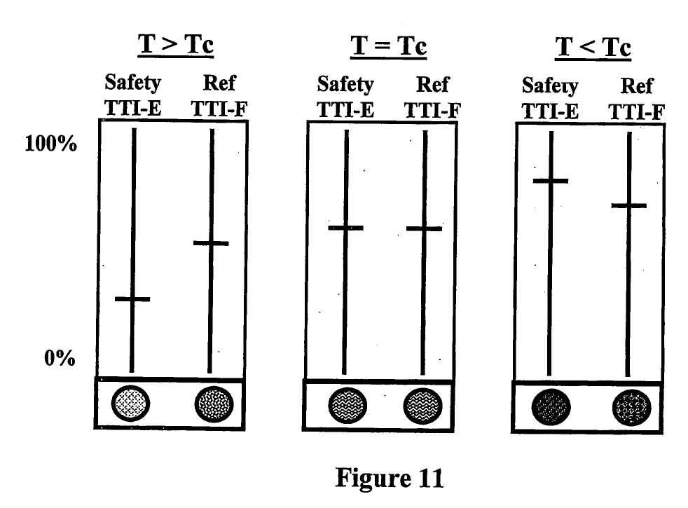

If the rate of change of color of the first (safety) TTI is greater than the change of color in the second (reference) TTI, then the food product was exposed to temperatures greater than the critical temperature (T_{c}) and the food supply chain should be investigated. If the rate of change of color is equal in both TTIs, then the food product was either exposed to temperatures consistently equal to the T_{c} or the product experienced offsetting higher and lower thermal conditions. If the rate of change of the first (safety) TTI is greater than the rate of change of the second (reference) TTI, then the product was handled well and the thermal history was mostly below the critical temperature. These types of response patterns are illustrated in FIG. 11.

All patents, patent applications, provisional applications, and publications referred to or cited herein are incorporated by reference in their entirety, including all figures and tables, to the extent they are not inconsistent with the explicit teachings of this specification.

### REFERENCES

Baker D. A., Genigeorgis, C. A. “Predicting the safe storage of fresh fish under modified atmospheres with respect to Clostridium botulinum toxigenesis by modeling length of the lag phase of growth”, J. Food Protect. (1990), 53:131-40.
Food and Drug Administration (FDA), Fish and fishers products hazards and controls guide, (1998, 2^{nd} ed.), Washington, D.C.
Food and Drug Administration (FDA), Fish and Fishery Products Hazards and Controls Guide, (2001, 3^{rd} ed.), Washington, D.C.
Federal Register, Mar. 15, 1990, Vol. 55, No. 51, Alpha Omega Technology, Inc. Petition.
Gerdes, D. L., Valdez S. “Modified atmosphere packaging of commercial pacific red snapper (Sebastes entomelas, Sebastes flavidus or Sebastes goodie)”, Lebensm. Wiss. U. Technol. (1991), 24:256-8.
Hong, L. C., Leblanc, E. L., Hawrysh, Z. J., Hardin, R. T. “Quality of Atlantic mackerel (Scomber scombrus L.) fillets during modified atmosphere storage”, J Food Sci (1996), 61(3):646-51.

Penney, N., Graham-Bell, R., Cummings, T. L. “Extension of the chilled storage life of smoked blue cod (Parapercis Colias) by carbon dioxide packaging”, Int J Food Sci Technol (1994), 29:167-78.

Post, P. S., Lee, D. A., Solberg, M., Furhgang, D., Specchio, J., Graham, C. “Development of botulinal toxin and sensory deterioration during storage of vacuum and modified atmosphere packaged fish fillets”, J Food Sci (1985), 50:990-6.
Price, R. J. “Why seafood spoils” The National Seafood Database, Grant Nr. NA85AA-D-SG140, Project Nr. A/EA-1, California Sea Grant College Program (1990), Available at: http://foodsafety.ifas.ufl.edu/HTML/sea.htm
Reddy, N. R., Paradis, A., Roman, M. G., Solomon, H. M., Rhodehamel, E. J. “Toxin development by Clostridium botulinum in modified atmosphere-packaged fresh tilapia fillets during storage”, J Food Sci (1996), 61(3):632-5.
Reddy, N. R., Roman, M. G., Villanueva, M., Solomon, H. M., Kantter, D. A., Rhodehamel, E. J. “Shelf life and Clostridium botulinum toxin development during storage of modified atmosphere-packaged fresh catfish fillets”, J Food Sci (1997a), 62(4):878-84.
Reddy, N. R., Solomon, H. M., Yep, H., Roman, M. G., Rhodehamel, E. J. “Shelf life and toxin development by Clostridium botulinum during storage of modified atmosphere-packaged fresh aquacultured salmon fillets”, J Food Protect (1997b), 60(9):1055-63.
Robertson, G. L. Food packaging, Ch 15, (1993), New York: Marcel Dekker, Inc.
Sarathchandra, S. U., Wolf, J., Barker, A. N. “Germination responses in 3 Clostridium species” In: Barker, A. N., Wolf J., Ellar, D. J., Dring, G. J., Gould, G. W., Spore research, (1977), New York, Academic Press, pp. 721-34.
Scarlatti, C. “System for preserving fresh fish on board deep-water vessels. In: Fish handling and preservation”, Organization for Economic Co-operation and Development, Paris (1965).
Shimoni, E., Anderson, E. M., Labuza, T. P. “Reliability of time temperature indicators under temperature abuse”, J Food Sci (2001), 66(9):1337-40.
Skinner, G. E., Larkin, J. W. “Conservative prediction of time to Clostridium botulinum toxin formation for use with time-temperature indicators to ensure the safety of foods”, J Food Protect (1998), 61(9):1154-60.
Stammen, K, Gerdes, D., Caporaso, F. “Modified atmosphere packaging of seafood”, Critical Rev Food Sci Nutr (1990), 29(5):301-31.
Welt, B. A., Teixeira, A. A., Chau, C. V., Balaban, M. O., Hintenlang, D. E. “Explicit finite difference methods for heat transfer simulation and thermal process design”, J Food Sci (1997), 62(2):230-6.

1. An improved time temperature integrator system comprising time temperature integrators comprising a reaction rate mechanism having a reaction rate constant (k); wherein the reaction rate mechanism exhibits temperature sensitivity; wherein the improvement comprises a reaction rate mechanism that exhibits zero-order decay when exposed to a temperature, measured in Kelvin, according to the equation
$${e}^{[ 64.86 - \frac{17311}{Temp ( K )} ]} .$$

2. An improved fresh food and perishable products monitoring system comprising time temperature integrators comprising a reaction rate mechanism having a reaction rate constant (k); wherein the reaction rate mechanism exhibits temperature sensitivity; wherein the reaction rate mechanism decays when exposed to temperature; wherein the improvement comprises a reaction rate mechanism approximated by reaction kinetic schemes.

3. The system according to claim 2, wherein the reaction rate mechanism of a safety time temperature integrator exhibits zero-order decay when exposed to temperature.

4. The system according to claim 3, wherein the zero-order decay of the reaction rate mechanism of a safety time temperature integrator approximates depletion of lag time for pathogenic microorganisms.

5. The system according to claim 4, wherein the pathogenic microorganism is selected from the group consisting of C. Botulinum, enterotoxigenic E. coli, salmonellae sp, exotoxin shigalla dysenteriae, staphylococcus aureus, enterotoxin Klebsiella pneumoniae, Bacillus cereus, Vibrio parahaemolyticus, Vibrio cholerae, Campylobacter jejuni, Campylobacter jejuni, Yersinia enterocolitica, Exotoxin Pseudomonas aeruginosa, C. perfringens, Versinia enterocolitica, and Listeria monocytogenes.

6. The system according to claim 3, wherein the reaction rate mechanism of a safety time temperature integrator approximates depletion of lag time for temperature sensitive phenomena selected from the group consisting of sprouting, ripening, and spoiling.

7. The system according to claim 2, wherein a natural log of a reference time temperature integrator's reaction rate constant is equivalent to a natural log of a safety temperature integrator's reaction rate constant at a critical temperature.

8. The system according to claim 2, wherein the decay of the reaction rate mechanism of a reference time temperature integrator indicates fluctuations in temperature.

9. The system according to claim 2, wherein a temperature sensitivity of a reference time temperature integrator's reaction mechanism is different than a temperature sensitivity of a safety time temperature integrator's reaction mechanism.

10. The system according to claim 2, wherein the reaction kinetic scheme is zero-order.

11. The system according to claim 2, wherein the reaction kinetic scheme is first-order.

12. The system according to claim 2, wherein the reaction rate mechanism is a function of temperature and is optionally estimated using fitting functions.

13. The system according to claim 12, wherein the reaction rate mechanism is estimated using fitting functions.

14. The system according to claim 13, wherein the fitting function is a zero-order approximation.

15. The system according to claim 13, wherein the fitting function is a first-order approximation.

16. A method for monitoring perishability and safety of fresh food or other perishable products, wherein the method comprises:
a) providing a fresh food and perishable products monitoring system of claim 1;
b) attaching the fresh food and perishable products monitoring system to a packaged fresh food or perishable product;
c) observing the rates of change in each of the time temperature integrators; and
d) comparing the rates of change in each of the time temperature integrators.

17. The method according to claim 16, wherein rate of change is indicated visually by a change of color; wherein the observing step comprises measuring the change in color with a spectrometer or a color chart.

18. The method according to claim 16, wherein the rate of change, extent of reaction of each of the time temperature integrators or both the rate of change and extent of reaction of each of the time temperature integrators is calculated.

19. The method according to claim 16, wherein the calculation performed by each of the time temperature integrators is displayed digitally, as a change of color, by a variable indication against a fixed scale or any combination thereof.

20. The method according to claim 16, wherein the perishable product is a reduced-oxygen package of fresh fish.

21-22. (canceled)

23. The method according to claim 18, wherein the calculation performed by each of the time temperature integrators is displayed digitally, as a change of color, by a variable indication against a fixed scale or any combination thereof.
